(19) United States
(12) Patent Application Publication
(10) Pub. No.: US 2018/0219822 A1
(43) Pub. Date: Aug. 2, 2018

(54) System and Method for Smart and Secure e-Mail using Per-Recipient Attributes

(71) Applicant: DELL PRODUCTS, LP, Round Rock, TX (US)

(72) Inventors: Sathish K. Bikumala, Round Rock, TX (US); Shibi Panikkar, Bangalore (IN)

(21) Appl. No.: 15/420,805

(22) Filed: Jan. 31, 2017

(51) Int. Cl. H04L 12/58

(52) U.S. Cl. CPC H04L 51/14; H04L 51/22; H04L 51/34

(57) ABSTRACT

An information handling system includes a memory having machine-executable code, and a processor configured to execute the code. The code is configured to launch an e-mail client on the information handling system. The e-mail client determines a first per-recipient attribute for a first recipient who is a first addressee of an e-mail, determines a second per-recipient attribute for a second recipient who is a second addressee of the e-mail, sends a first instantiation of the e-mail to the first recipient based upon the first per-recipient attribute, and sends a second instantiation of the e-mail to the second recipient based upon the second per-recipient attribute. The first per-recipient attribute is different from the second per-recipient attribute.

### FIELD OF THE DISCLOSURE

This disclosure generally relates to information handling systems, and more particularly relates to smart and secure e-mail using per-recipient attributes.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

An information handling system may include a memory having machine-executable code, and a processor configured to execute the code. The code may be configured to launch an e-mail client on the information handling system. The e-mail client may determine a first per-recipient attribute for a first recipient who is a first addressee of an e-mail, determine a second per-recipient attribute for a second recipient who is a second addressee of the e-mail, send a first instantiation of the e-mail to the first recipient based upon the first per-recipient attribute, and send a second instantiation of the e-mail to the second recipient based upon the second per-recipient attribute. The first per-recipient attribute may be different from the second per-recipient attribute.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of an e-mail system according to an embodiment of the present disclosure:

FIGS. 2-4 illustrate an e-mail being created by a sender, including per-recipient attributes, according to an embodiment of the present disclosure;

FIGS. 5 and 6 illustrate e-mails generated by an e-mail server based upon the per-recipient attributes from the e-mail of FIGS. 2-4;

FIG. 7 illustrates a method for smart and secure e-mail using per-recipient e-mail attributes according to an embodiment of the present disclosure; and

FIG. 8 is a block diagram illustrating a generalized information handling system according to an embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

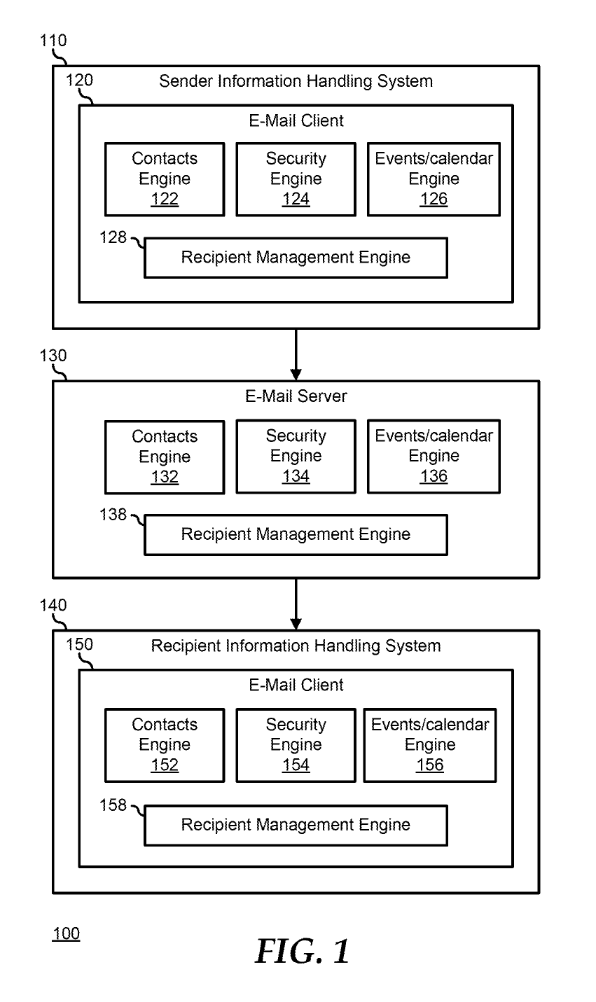

FIG. 1 illustrates an embodiment of an e-mail system 100 implemented on various information handling systems. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system can be a personal computer, a laptop computer, a smart phone, a tablet device or other consumer electronic device, a network server, a network storage device, a switch router or other network communication device, or any other suitable device and may vary in size, shape, performance, functionality, and price. Further, an information handling system can include processing resources for executing machine-executable code, such as a central processing unit (CPU), a programmable logic array (PLA), an embedded device such as a System-on-a-Chip (SoC), or other control logic hardware. An information handling system can also include one or more computer-readable medium for storing machine-executable code, such as software or data. Additional components of an information handling system can include one or more storage devices that can store machine-executable code, one or more communications ports for communicating with external devices, and various input and output (I/O) devices, such as a keyboard, a mouse, and a video display. An information handling system can also include one or more buses operable to transmit information between the various hardware components.

E-mail system 100 includes a sender information handling system 110, an e-mail server 130, and a recipient information handling system 140. Sender information handling system 110 includes an e-mail client 120, and recipient information handling system 140 includes an e-mail client 150. E-mail clients 120 and 150 and e-mail server 130 represent programs or applications to facilitate the creation, editing, sending, routing, receiving, and displaying of electronic communications (e-mails) between a sender and one or more recipients. In particular, e-mail clients 120 and 150 and e-mail server 130 operate at the application layer (L7) of the Open System Interconnect (OSI) model to send, receive, and route e-mails over a Transmission Control Protocol/Internet Protocol (TCCP/IP) connection between sender information handling system 110, e-mail server 130, and recipient information handling system 140. As such, e-mail clients 120 and 150 and e-mail server 130 operate in accordance with one or more operating standards for e-mail communication. An example of an operating standard for e-mail communication includes a Post Office Protocol version 3 (POP3) standard or an Internet Message Access Protocol (IMAP) standard for receiving e-mails, a Simple Mail Transfer Protocol (SMTP) standard for sending e-mails, a Multi-Purpose Internet Mail Extensions (MIME) standard for e-mail formatting, or other e-mail communication standards, as needed or desired. Details of the standards for e-mail communication will not be described further herein, except as needed to show the functions and features of the present disclosure.

E-mail client 120 represents an integrated e-mail management program or application that may provide a graphical user interface for the management of the creation, composition, addressing, and sending of e-mail to the one or more recipients. An example of e-mail client 120 includes various Windows-based e-mail clients such as Microsoft Outlook or Windows Mail for a Microsoft Windows operating environment, various MacOS-based e-mail clients such as AppleMail, various cross-platform or web-based e-mail clients such as G-Mail, Yahoo Mail, or AOL mail, or another e-mail client, as needed or desired. In a particular embodiment, e-mail client 120 represents a portion of a larger integrated productivity platform operating on sender information handling system 110, that operates to manage other e-mail related activities such as the storage, filing, and archiving of received e-mail, document creation, contacts management, calendar and event management, and other office productivity activities.

As such, e-mail client 120 includes a contacts engine 122, a security engine 124, an events/calendar engine 126, and a recipient management engine 128. Contacts engine 122 operates to store and maintain a list of e-mail contacts, or addressees, for a user of sender information handling system 110. The e-mail contacts can include lists of e-mail contacts associated with an enterprise that the user belongs to, such as a corporate e-mail contact list. The e-mail contacts can also include lists of e-mail contacts that are personal to the user. As illustrated herein, contacts engine 122 resides with and operates on e-mail client 120, but this is not necessarily so, and the contacts engine can also represent access to remotely stored contacts lists, such as a contact list maintained on e-mail server 130 or elsewhere, such as on a cloud computing system. Security engine 124 represents a content access and control system, such as may be associated with the enterprise that the user belongs to, and that maintains the access confidentiality and integrity of documents related to the enterprise. For example, security engine 124 may operate to remove documents that are marked as confidential within the enterprise if the document is attached to an e-mail that includes recipients that are not associated with the enterprise, or may operate to ensure that confidential documents are not edited prior to sending the documents. Security engine 124 thus operates to enforce a security policy of an enterprise in the operations surrounding creating a particular e-mail. Events/calendar engine 126 operates to integrate e-mail activities with the user's events, alerts, action-items, and calendar activities. For example, an e-mail sent to particular recipients may include a calendar event for the recipients to accept, or items to be added to the recipients' “to-do” list.

It will be understood that e-mail client 120, in conjunction with contacts engine 122, security engine 124, and events/calendar engine 126, can operate to provide various e-mail-level attributes to the e-mails generated on the e-mail client. For example, a particular e-mail may be marked by the user of sender information handling system 110 with various security attributes, such as marking the e-mail as confidential, as requiring encryption prior to sending, as enabling voting replies to the sender, as requiring delivery or read receipts from the recipients to the sender, as having a particular importance level, as having a delivery date, as indicating that a “to-do” or calendar item is included in the e-mail, or as having other globally applied attributes, as needed or desired. such e-mail-level attributes are ascribed to the particular e-mail, and are applied to all recipients equally. However, such globally applied attributes can lead to various problems. For example, where an e-mail is marked as having a high importance, all recipients will receive the indication that the e-mail has a high importance. However, this may not be true for all recipients. For example, an e-mail from a manger may have high importance for the employees that work for the manager, but may be merely informational for recipients that are upstream from the manager (i.e., the manager's managers). Here, the manager is faced with the choice of marking the e-mail as having a high importance for all recipients, thereby giving the manager's managers a false impression of the importance of the particular e-mail, or the manager may separately send the particular e-mail to the employees marked with a high priority and resent the particular e-mail to the managers marked with a low priority.

E-mail client 150 is similar to e-mail client 120 and may represent a different integrated e-mail management program or application that provides a graphical user interface for the management of the creation, composition, addressing, and sending of e-mail to the one or more recipients. Further, e-mail client 150 may represent a portion of a different integrated productivity platform operating on recipient information handling system 140. As such, e-mail client 150 includes a contacts engine 152 similar to contacts engine 122, a security engine 154 similar to security engine 124, an events/calendar engine 156 similar to events/calendar engine 126, and a recipient management engine 158 similar to recipient management engine 128. Within the context of receiving an e-mail from sender information handling system 110, security engine 154 operates to ensure that the content and attachments received in a particular e-mail are handled in accordance with the security operations dictated by the security policy of the enterprise in the operations surrounding opening, reading, and changing of protected content of the particular e-mail. Similarly, events/calendar engine 156 operates to receive event and calendar items in received e-mails and to incorporate the event and calendar items to the recipient's to-do list and calendar.

E-mail server 130 operates to receive e-mails received from sender information handling system 110 and to forward the e-mails to the recipients marked on the e-mails, including to recipient information handling system 140. In a particular embodiment, e-mail server 130 represents a resource of the enterprise that employs e-mail system 100, and actively participates in the management of client lists, security policies, event and calendar items, and the like. Accordingly, e-mail server 130 includes a contacts engine 132, a security engine 134, an events/calendar engine 136, and a recipient management engine 138. Contacts engine 132 maintains a master contacts list for e-mail system 100. Security engine 134 maintains a security policy for the e-mail system and ensures the proper handling of confidential information in accordance with the security policy. For example, security engine 134 can include a list of recipients who may receive confidential information. Here, a user of sender information handling system 110 may inadvertently create an e-mail that includes confidential information, and also includes one or more recipient that is not authorized to view the confidential information. Here, further, e-mail server 130 may operate to drop the unauthorized recipient from the e-mail and thus only forward the e-mail to the authorized recipients. Events/calendar engine 136 operates to maintain a global to-do list and calendar for the enterprise, such that, when a received e-mail includes an event or calendar item for a recipient within the enterprise, the events/calendar engine updates the recipient's to-do list or calendar with the received event or calendar item. It will be understood that e-mail server 130, in conjunction with contacts engine 132, security engine 134, and events/calendar engine 136, can operate to enforce the various e-mail-level attributes to the e-mails generated on e-mail client 120.

Recipient management engines 128, 138, and 158 operate to provide per-recipient classification, security, purpose, relevance, intention, and context to e-mails handled on e-mail system 100. In particular, when an e-mail is created, a user of sender information handling system 110 selects one or more recipient to receive the e-mail. Recipient management engine 128 then operates to determine if any of the recipients are new recipients for e-mails from the user of sender information handling system 110. If so, recipient management engine 128 provides the user with a menu of options for ascribing a classification, a security level, a purpose, a relevance, an intention, a context, or other attributes to e-mails sent to the new recipient. Then, when any future e-mails are sent from the user of sender information handling system 110 to that same new recipient, recipient management engine 128 ascribes the selected attributes associated with the new recipient to the future e-mails, as a default set of attributes. As an option, the user of information handling system 110 can also select one-time attributes to associate with a recipient of a particular e-mail, instead of applying the default attributes associated with the recipient.

Then, when the user of sender information handling system 110 is finished creating a particular e-mail, and selects to send the e-mail, recipient management engine 128 operates to edit the e-mail to include a recipient table including all of the recipients and their associated recipient attributes, and e-mail client 120 sends the e-mail to e-mail server 130. When e-mail server 130 receives an e-mail, recipient management engine 138 operates to determine if the e-mail includes a recipient table. If so, recipient management engine 138 operates to parse the e-mail by recipients, and to apply the particular attributes to individual e-mails for each recipient. For example, consider where e-mail server 130 receives an e-mail including a confidential attachment that is addressed to two recipients: a first who is permitted to receive the confidential attachment, and a second who is not permitted to receive the confidential attachment. Here, recipient management engine 138 operates to create two separate e-mails from the received e-mail: a first e-mail that includes the confidential attachment to the first recipient, and a second e-mail that does not include the confidential attachment to the second recipient. In a particular embodiment, recipient management engine 128 removes entries from the recipient table for all other recipients than the intended recipient, to keep the various recipient attributes confidential. In this way, the e-mail traffic on e-mail system 100 is not increased, because the amount of e-mail traffic between sender information handling system 110 and e-mail server 130 remains the same (i.e., one e-mail is sent between the sender information handling system and the e-mail server). However, it will be understood that, in this embodiment, the amount of data processing performed by e-mail server 130 will be increased by the need to separately process the outgoing e-mails to the different recipients. In another embodiment, recipient management system 120 in sender information handling system 110 operates to create two separate e-mails from the original e-mail: a first e-mail that includes the confidential attachment to the first recipient, and a second e-mail that does not include the confidential attachment to the second recipient. Here, sender information handling system 110 increases the amount of e-mail traffic on e-mail system 100, but e-mail server 130 is consequently freed from providing the additional data processing needed to separate the e-mails.

Finally, when recipient information handling system 140 receives an e-mail from e-mail server 130 that includes a recipient table for a user of the recipient information handling system, recipient management engine 158 operates to enforce the various attributes for the recipient. For example, if the user of recipient information handling system 140 receives an e-mail with a recipient table that includes an attribute that dictates that the e-mail should not be forwarded, then recipient management engine 158 operates to prevent forwarding of the e-mail. In a particular embodiment, the attributes associated with a particular recipient are centrally maintained, such as on e-mail client 130, and are distributed to sender information handling system 110 and recipient information handling system 140. Here, when an e-mail is received for a particular recipient by recipient information handling system 140, recipient management engine 158 operates to check the e-mail to determine if it is in compliance with the attributes associated with the recipient. If the e-mail is in some way non-compliant, then recipient management engine 158 operates to correct the attributes before presenting the e-mail to the recipient. For example, where a recipient is restricted from receiving a particular document, recipient management engine 158 can check incoming e-mails for the document, and if any e-mails include the document, the recipient management engine can operate to remove the document from the e-mail before presenting the e-mail to the recipient.

The inclusion of per-recipient attributes to e-mails provides various improvements over per-e-mail attributes. In particular, security concerns regarding e-mail delivery are quickly and efficiently handled by ensuring that recipients who are not permitted to view confidential content can be copied on e-mails to recipients who are permitted to view confidential content, without the sender having to craft individual e-mails to each group of recipients. Further, security can be ensured at the e-mail server level, such that, if a recipient is not initially set up as not permitted to view confidential content, the e-mail server can enforce security rules by appending the correct security attributes to e-mail recipients who are not permitted to view the confidential content. Further, classification and relevance can be handled based upon various group affiliations for the recipients. For example, all of a manager's e-mails that are sent to the manager's employees can be sent with a high priority, while e-mails to the manger's managers can be sent with a lower priority or an “information only” attribute. In another example, certain recipients can be provided with an attribute which automatically archives e-mails for, for example, a particular project or activity.

Per-recipient attributes also permit the selective implementation of intention and context for various groups of recipients. For example, where a voting feature is enabled on an e-mail, only certain recipients may be permitted to vote, while others are not. For example, where an e-mail to a corporate board includes a proposal to be voted on by the board members, per-recipient attributes can be provided that enables voting for the board member recipients, but not for a recipient who is a clerk or secretary to the board. Further, where two or more recipients have a same name, a per-recipient attribute specifying that an action included in the e-mail is directed to one of the recipients and not to the other can mitigate undue confusion in the recipients. Other context attributes may relate to the type of signature block or e-business card that is attached to the e-mail, based upon whether or not the recipient is a part of an enterprise or is outside of the enterprise. For example, a signature block or e-business card for recipients within an enterprise may include a cell phone number for the sender, while external recipients may receive a different signature block or e-business card that does not include the cell phone number. Further, a particular recipient may be provided with a time-based attribute, such as a “deliver after” time or date. In this way, proposals to a manager can be delayed in order to give team members time to vet the proposals.

In a particular embodiment, recipient management engine 138 operates to encrypt all of the content, including the text and attachments, of the e-mails that include a recipient table, and recipient management engine 158 operates to decrypt encrypted e-mails from e-mail server 130. In this way, restrictive attributes can not be ignored by an e-mail client that does not include a recipient management engine, because the e-mail client will not include the decryption key to decrypt the e-mails received from e-mail server 130.

Finally, by providing recipient management engine 138 in e-mail server 130, the functions and features of the per-recipient attributes can be applied to e-mail from a particular sender and to a particular recipient, even if the sender creates the e-mail on an information handling system the does not include a recipient management engine. For example, a user may craft an e-mail on a web-based e-mail program or a cell phone that does not include a recipient management engine, but recipient management engine 138 can receive the e-mail and apply pre-determined recipient attributes to the e-mail before forwarding the e-mail to the addressees. In another embodiment, recipient management engine 128 incorporates the functions and features of recipient management engine 138. Here, e-mail server 130 operates as a typical e-mail server, and does not participate in the functions and operations of applying per-recipient attributes to e-mails, as described above. In this way, the implementation of the described application of per-recipient attributes to e-mails is performed on sender information handling system 110 and on recipient information handling system 140. A particular advantage of the present embodiment, is that the application of per-recipient attributes can be performed by information handling systems for, for example, an enterprise, that utilizes an independent service for the provision of e-mail services, and where the independent service does not support the application of per-recipient attributes to e-mails handled by the independent service.

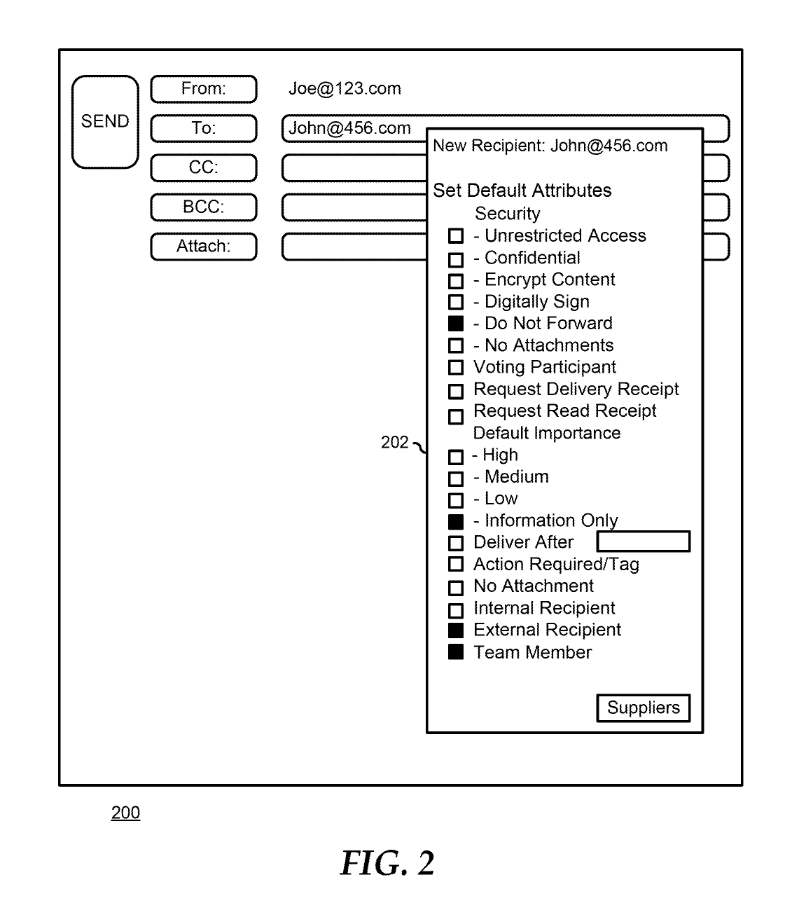

FIG. 2 illustrates an e-mail 200 being created by a sender (Joe@123.com) to a recipient (John@456.com). A recipient management engine in the information handling system used by the sender determines that the present e-mail is a first time that John@456.com has been addressed as a recipient by Joe@123.com. As such, the recipient management engine provides a new recipient pop-up window 202 in e-mail 200 that provides for the selection of default attributes to be supplied to all future e-mails that are addressed to John@456.com. Note that, as illustrated, any future e-mails sent from Joe@123.com to John@456.com will be provided with a “Do Not Forward” attribute, will be tagged with a default importance attribute of “Information only,” will be marked with an “External Recipient” attribute, and will be marked as being part of a team titled “Suppliers.”

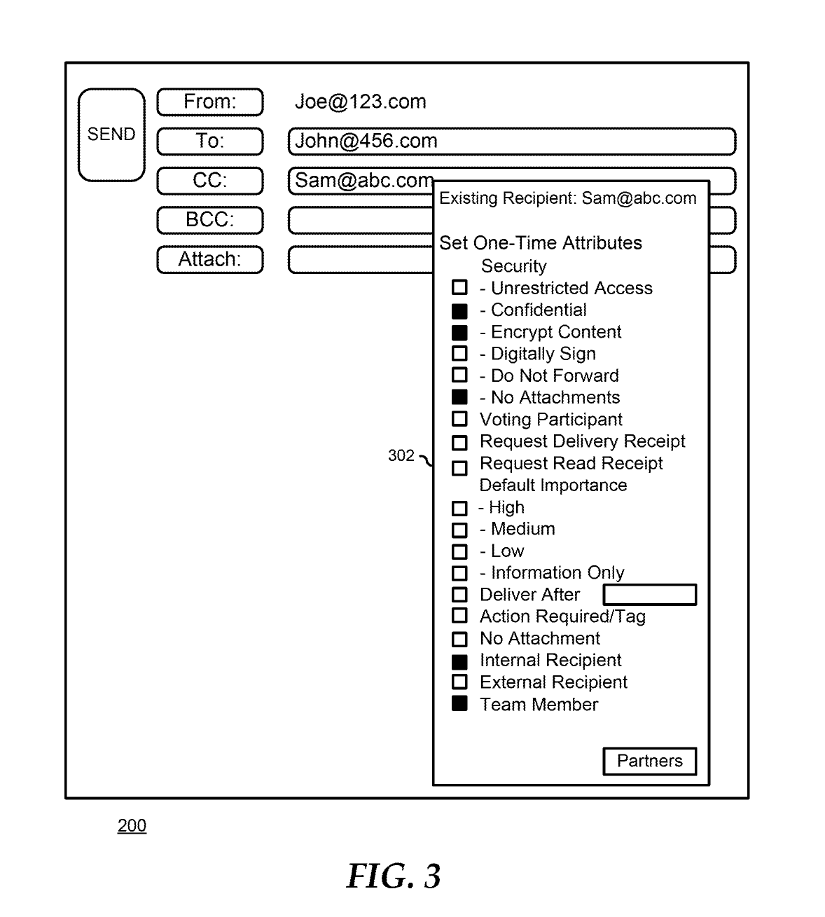

FIG. 3 illustrates continuing progress in creating e-mail 200 where a “CC” recipient (Sam@abc.com) has been added. Sam@abc.com is not a new recipient, and so no action is necessary to ascribe per-recipient attributes. However, the recipient management engine can be invoked to provide one-time attributes to the recipient Sam@abc.com for e-mail 200. For example, the sender can right-click on the e-mail address for Sam@abc.com in order to provide a pop-up window 302 that provides for the selection of one-time attributes to be supplied to e-mail 200. Note that, as illustrated, e-mail 200 will be provided with one-time security attributes, including a “Confidential” attribute, an “Encrypt Content” attribute, and a “No Attachment” attribute. E-mail 200 will also be marked with an “Internal Recipient” attribute, and will be marked as being part of a team titled “Partners.”

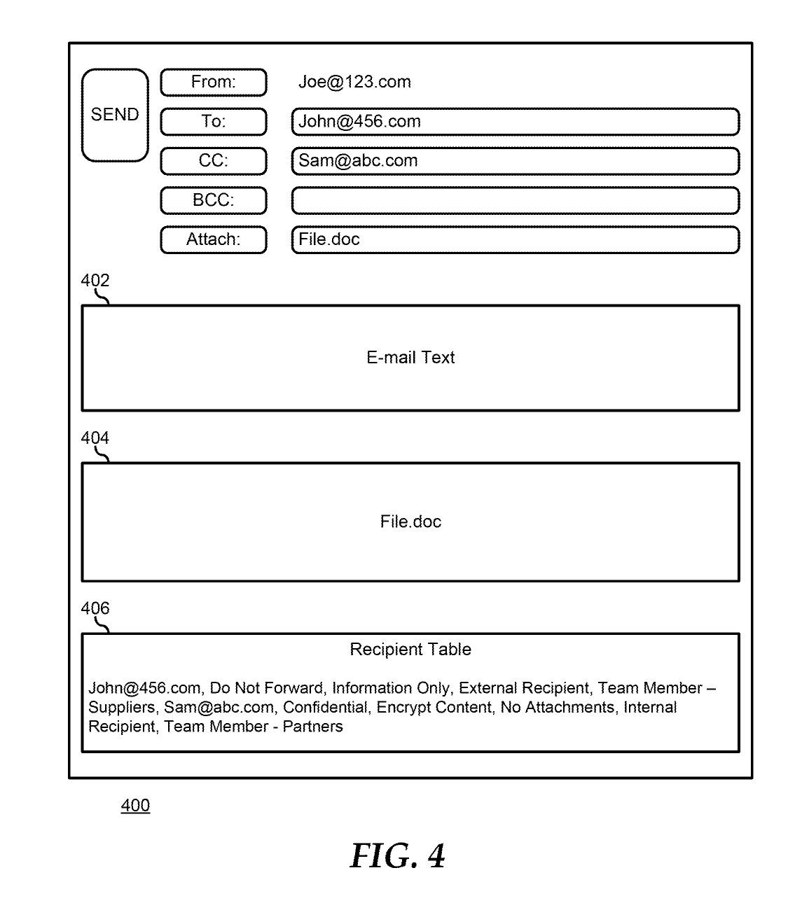

FIG. 4 illustrates a completed e-mail 400 where the sender has added e-mail text 402, and has attached a document 404 (File.doc). In addition, the recipient management engine has added a recipient table 406 that includes the per-user attributes for the recipients: John@456.com and Sam@abc.com. In a particular embodiment, recipient table 406 is provided as a comma-separated-value (CSV) table with the attributes listed for each recipient, separated by a comma. Other table formats may be utilized as needed or desired. In a particular embodiment, the recipient management engine encrypts one or more of e-mail text 402, document 404, and recipient table 406. The sender then selects to send e-mail 400 to an e-mail server for further handling.

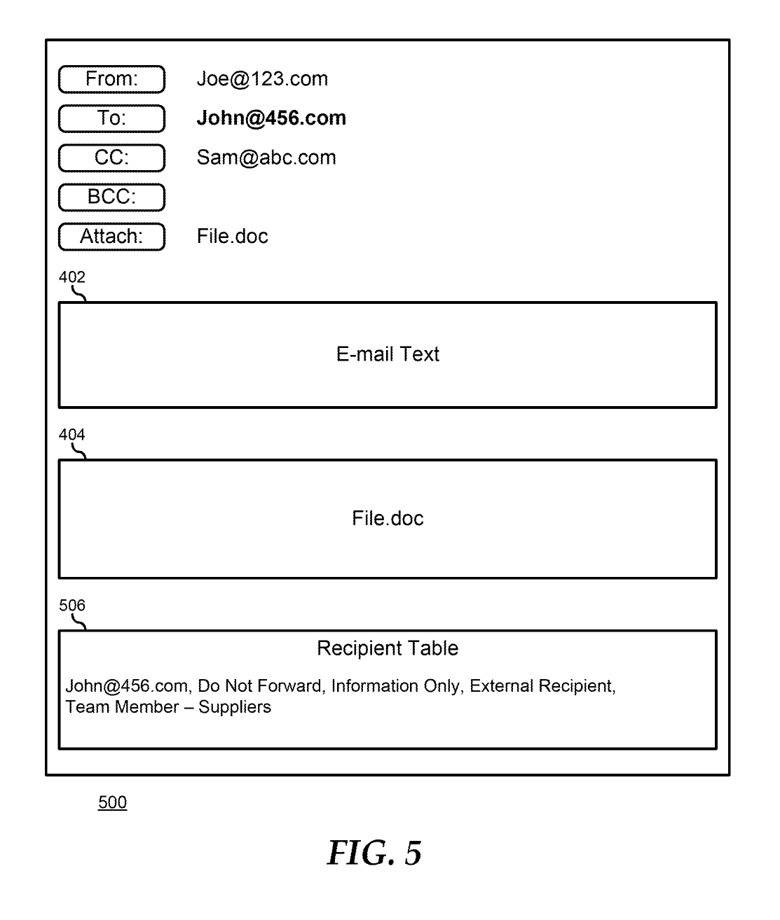

FIG. 5 illustrates a first e-mail 500 generated by the e-mail server from e-mail 400 of FIG. 4. In particular, e-mail 500 is generated from e-mail 400 for the recipient John@456.com. Here, John@456.com is permitted to receive both the e-mail text 402 and the attached document 404. Further, the e-mail server operates to remove the recipient attribute information for Sam@abc.com from recipient table 506. E-mail 500 is then sent to the addressee, John@456.com.

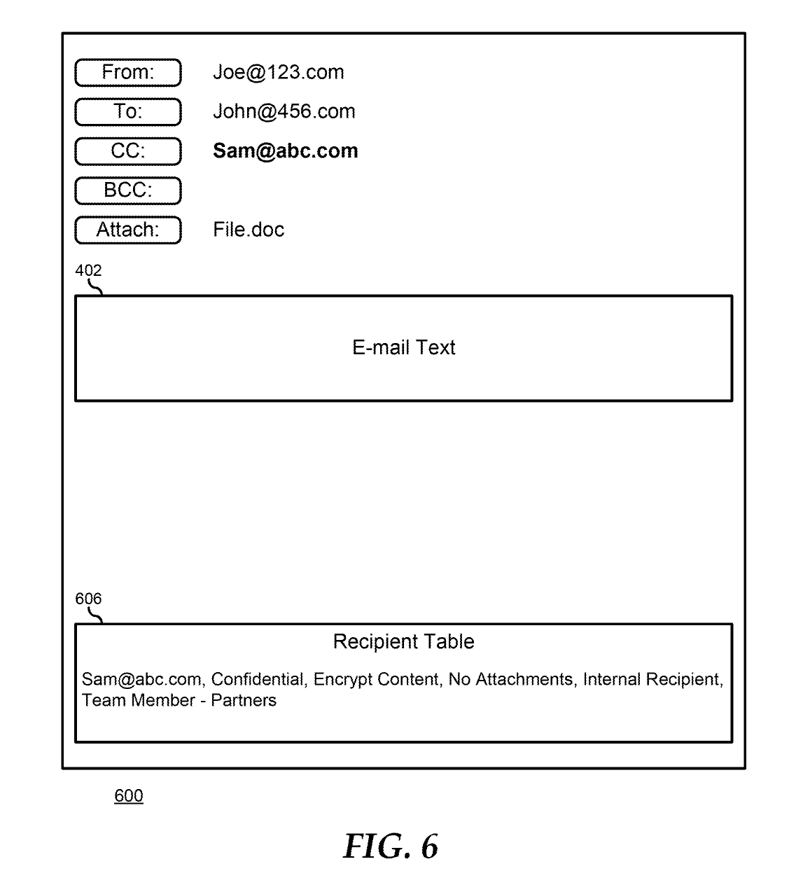

FIG. 6 illustrates a second e-mail 600 generated by the e-mail server from e-mail 400 of FIG. 4. In particular, e-mail 600 is generated from e-mail 400 for the recipient Sam@abc.com. Here, Sam@abc.com is permitted to receive only the e-mail text 402 and not the attached document 404 because Sam@abc.com is ascribed the “No Attachments” attribute. The e-mail server also operates to remove the recipient attribute information for John@456.com from recipient table 606. E-mail 600 is then sent to the addressee, Sam@abc.com.

Note that, in general, any attribute which may be ascribed to an e-mail on a per-e-mail basis may also be ascribed to the recipients of an e-mail on a per-recipient basis, and the attributes described herein are not representative, nor exhaustive of the set of attributes that may be ascribed to an e-mail on a per-recipient basis, and other attributes may be ascribed to an e-mail on a per-recipient basis, as needed or desired.

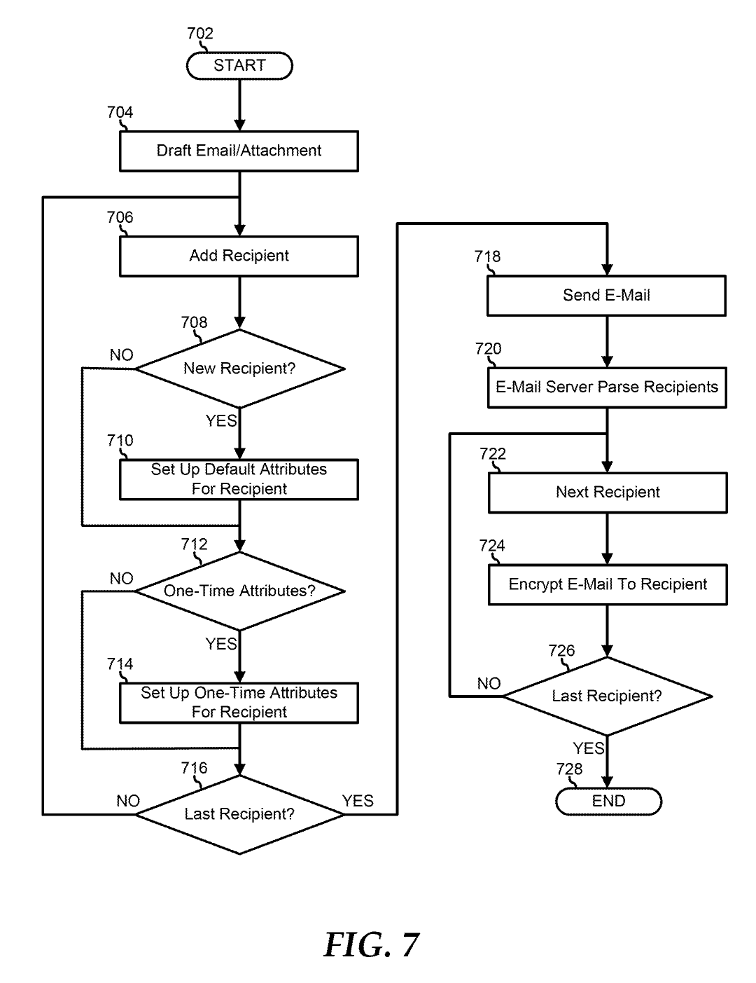

FIG. 7 illustrates a method for smart and secure e-mail using per-recipient e-mail attributes starting at block 702. A sender drafts an e-mail in block 704. The e-mail may include one or more attachments, as needed or desired. A recipient is added to the e-mail in block 706. A decision is made as to whether or not the recipient is a new recipient of e-mails from the sender in decision block 708. For example, a recipient management engine of an e-mail client on the information handling system used by the sender can determine if the sender has previously sent an e-mail to the recipient. If not, the “NO” branch of decision block 708 is taken and the method proceeds to decision block 712, as described below. If the recipient is a new recipient of e-mails from the sender, the “YES” branch of decision block 708 is taken, the sender is prompted to set up default attributes for the recipient in block 710 and the method proceeds to decision block 712.

In decision block 712, a decision is made as to whether or not the sender wishes to set up one-time attributes for the recipient. If not, the “NO” branch of decision block 712 is taken and the method proceeds to decision block 716, as described below. If the sender wishes to set up one-time attributes for the recipient, the “YES” branch of decision block 712 is taken, the sender is prompted to set up the one-time attributes for the recipient in block 714, and the method proceeds to decision block 716. A decision is made as to whether or not the recipient is the last recipient for the e-mail in decision block 716. If not, the “NO” branch of decision block 716 is taken and the method returns to block 706 where another recipient is added to the e-mail. If the recipient is the last recipient for the e-mail, the “YES” branch of decision block 716 is taken and the e-mail is sent from the sender's information handling system to the e-mail server in block 718. A recipient management engine of the e-mail server parses the recipients in the e-mail into individual e-mails to each recipient in block 720.

A first recipient is selected in block 722 and the recipient management engine encrypts the e-mail to the first recipient and sends the encrypted e-mail to the first recipient in block 724. A decision is made as to whether or not the last recipient e-mail has been sent in decision block 726. If so, the “YES” branch of decision block 726 is taken and the method ends in block 728. If the last recipient e-mail has not been sent, the “NO” branch of decision block 726 is taken and the method returns to block 722 where a next recipient is selected. Note that, as described above, in a particular embodiment, the sender information handling system can perform the operations of blocks 720 through 726 of encrypting and parsing of the e-mails to the various recipients prior to sending the e-mails as described in block 718. In this way, the processing overhead is provided by the sender information handling system.

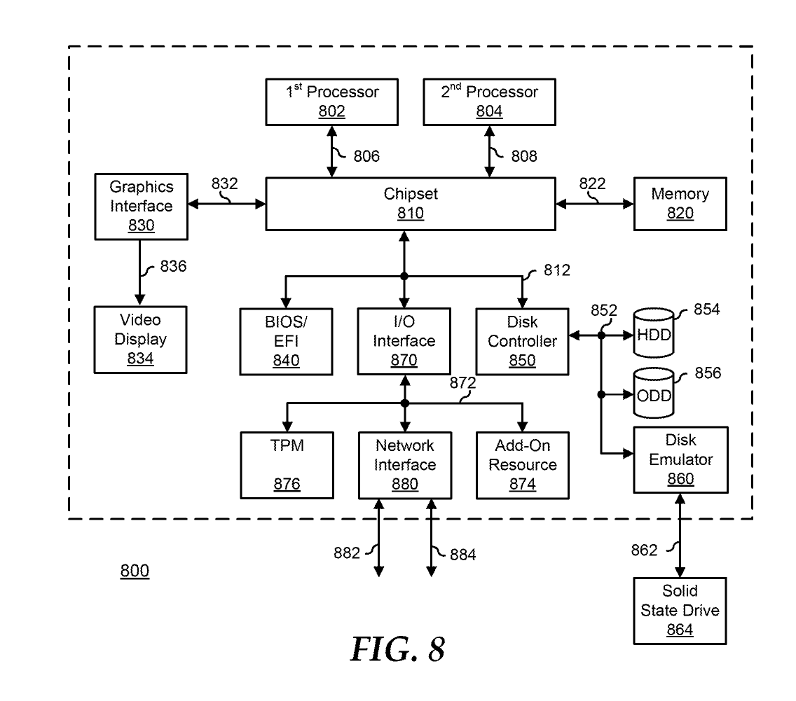

FIG. 8 illustrates a generalized embodiment of information handling system 800. For purpose of this disclosure information handling system 800 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 800 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 800 can include processing resources for executing machine-executable code, such as a central processing unit (CPU), a programmable logic array (PLA), an embedded device such as a System-on-a-Chip (SoC), or other control logic hardware. Information handling system 800 can also include one or more computer-readable medium for storing machine-executable code, such as software or data. Additional components of information handling system 800 can include one or more storage devices that can store machine-executable code, one or more communications ports for communicating with external devices, and various input and output (I/O) devices, such as a keyboard, a mouse, and a video display. Information handling system 800 can also include one or more buses operable to transmit information between the various hardware components.

Information handling system 800 can include devices or modules that embody one or more of the devices or modules described above, and operates to perform one or more of the methods described above. Information handling system 800 includes a processors 802 and 804, a chipset 810, a memory 820, a graphics interface 830, include a basic input and output system/extensible firmware interface (BIOS/EFI) module 840, a disk controller 850, a disk emulator 860, an input/output (I/O) interface 870, and a network interface 880. Processor 802 is connected to chipset 810 via processor interface 806, and processor 804 is connected to the chipset via processor interface 808. Memory 820 is connected to chipset 810 via a memory bus 822. Graphics interface 830 is connected to chipset 810 via a graphics interface 832, and provides a video display output 836 to a video display 834. In a particular embodiment, information handling system 800 includes separate memories that are dedicated to each of processors 802 and 804 via separate memory interfaces. An example of memory 820 includes random access memory (RAM) such as static RAM (SRAM), dynamic RAM (DRAM), non-volatile RAM (NV-RAM), or the like, read only memory (ROM), another type of memory, or a combination thereof.

BIOS/EFI module 840, disk controller 850, and I/O interface 870 are connected to chipset 810 via an I/O channel 812. An example of I/O channel 812 includes a Peripheral Component Interconnect (PCI) interface, a PCI-Extended (PCI-X) interface, a high speed PCI-Express (PCIe) interface, another industry standard or proprietary communication interface, or a combination thereof. Chipset 810 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/EFI module 840 includes BIOS/EFI code operable to detect resources within information handling system 800, to provide drivers for the resources, initialize the resources, and access the resources. BIOS/EFI module 840 includes code that operates to detect resources within information handling system 800, to provide drivers for the resources, to initialize the resources, and to access the resources.

Disk controller 850 includes a disk interface 852 that connects the disc controller to a hard disk drive (HDD) 854, to an optical disk drive (ODD) 856, and to disk emulator 860. An example of disk interface 852 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 860 permits a solid-state drive 864 to be connected to information handling system 800 via an external interface 862. An example of external interface 862 includes a USB interface, an IEEE 1394 (Firewire) interface, a proprietary interface, or a combination thereof. Alternatively, solid-state drive 864 can be disposed within information handling system 800.

I/O interface 870 includes a peripheral interface 872 that connects the I/O interface to an add-on resource 874, to a TPM 876, and to network interface 880.

Peripheral interface 872 can be the same type of interface as I/O channel 812, or can be a different type of interface. As such, I/O interface 870 extends the capacity of I/O channel 812 when peripheral interface 872 and the I/O channel are of the same type, and the I/O interface translates information from a format suitable to the I/O channel to a format suitable to the peripheral channel 872 when they are of a different type. Add-on resource 874 can include a data storage system, an additional graphics interface, a network interface card (NIC), a sound/video processing card, another add-on resource, or a combination thereof. Add-on resource 874 can be on a main circuit board, on separate circuit board or add-in card disposed within information handling system 800, a device that is external to the information handling system, or a combination thereof

Network interface 880 represents a NIC disposed within information handling system 800, on a main circuit board of the information handling system, integrated onto another component such as chipset 810, in another suitable location, or a combination thereof. Network interface device 880 includes network channels 882 and 884 that provide interfaces to devices that are external to information handling system 800. In a particular embodiment, network channels 882 and 884 are of a different type than peripheral channel 872 and network interface 880 translates information from a format suitable to the peripheral channel to a format suitable to external devices. An example of network channels 882 and 884 includes InfiniBand channels, Fibre Channel channels, Gigabit Ethernet channels, proprietary channel architectures, or a combination thereof. Network channels 882 and 884 can be connected to external network resources (not illustrated). The network resource can include another information handling system, a data storage system, another network, a grid management system, another suitable resource, or a combination thereof.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An information handling system, comprising:
a memory including machine-executable code; and
a processor configured to execute the code to:
launch an e-mail client on the information handling system;
determine, by the e-mail client, a first per-recipient attribute for a first recipient, the first recipient being a first addressee of an e-mail;
determine, by the e-mail client, a second per-recipient attribute for a second recipient, the second recipient being a second addressee of the e-mail, the first per-recipient attribute being different from the second per-recipient attribute;
send, by the e-mail client, a first instantiation of the e-mail to the first recipient based upon the first per-recipient attribute; and
send, by the e-mail client, a second instantiation of the e-mail to the second recipient based upon the second per-recipient attribute.

2. The information handling system of claim 1, the processor further configured to execute the code to:
determine, by the e-mail client, that the first recipient has not been a previous addressee; and
select, by the e-mail client, a first set of per-recipient attributes of a plurality of per-recipient attributes as a first default set of per-recipient attributes for the first recipient in response to determining that the first recipient has not been a previous addressee, wherein the first default set of per-recipient attributes includes the first per-recipient attribute.

3. The information handling system of claim 2, wherein sending the first instantiation of the e-mail is further based upon the first default set of per-recipient attributes.

4. The information handling system of claim 1, the processor further configured to execute the code to:
provide, by the e-mail client, a second set of per-recipient attributes of the plurality of per-recipient attributes as a second default set of per-recipient attributes for the second recipient.

5. The information handling system of claim 4, wherein the second default set of per-recipient attributes does not include the second per-recipient attribute.

6. The information handling system of claim 5, wherein sending the second instantiation of the e-mail is further based upon the second default set of per-recipient attributes.

7. The information handling system of claim 1, the processor further configured to execute the code to:
append, by the e-mail client, a first recipient table including a first address of the first recipient and the first per-recipient attribute to the first instantiation of the e-mail; and
append, by the e-mail client, a second recipient table including a second address of the second recipient and the second per-recipient attribute to the second instantiation of the e-mail.

8. The information handling system of claim 1, the processor further configured to execute the code to:
append, by the e-mail client, a recipient table including a first address of the first recipient, the first per-recipient attribute, a second address of the second recipient, and the second per-recipient attribute to the e-mail prior to sending the first instantiation of the e-mail and the second instantiation of the e-mail.

9. The information handling system of claim 1, the processor further configured to execute the code to:
encode, by the e-mail client, the e-mail and the recipient table prior to sending the first instantiation of the e-mail and the second instantiation of the e-mail.

10. The information handling system of claim 1, the processor further configured to execute the code to:
determine, by the e-mail client, a per-e-mail attribute for the e-mail, wherein sending the first instantiation of the e-mail and the second instantiation of the e-mail is further based upon the per-e-mail attribute.

11. A method, comprising:
launching, by a processor of an information handling system, an e-mail client on the information handling system;
determining, by the e-mail client, a first per-recipient attribute for a first recipient, the first recipient being a first addressee of an e-mail;
determining, by the e-mail client, a second per-recipient attribute for a second recipient, the second recipient being a second addressee of the e-mail, the first per-recipient attribute being different from the second per-recipient attribute;
sending, by the e-mail client, a first instantiation of the e-mail to the first recipient based upon the first per-recipient attribute; and
sending, by the e-mail client, a second instantiation of the e-mail to the second recipient based upon the second per-recipient attribute.

12. The method of claim 11, further comprising:
determining, by the e-mail client, that the first recipient has not been a previous addressee; and
selecting, by the e-mail client, a first set of per-recipient attributes of a plurality of per-recipient attributes as a first default set of per-recipient attributes for the first recipient in response to determining that the first recipient has not been a previous addressee, wherein the first default set of per-recipient attributes includes the first per-recipient attribute.

13. The method of claim 12, wherein sending the first instantiation of the e-mail is further based upon the first default set of per-recipient attributes.

14. The method of claim 11, further comprising:
providing, by the e-mail client, a second set of per-recipient attributes of the plurality of per-recipient attributes as a second default set of per-recipient attributes for the second recipient.

15. The method of claim 14, wherein the second default set of per-recipient attributes does not include the second per-recipient attribute.

16. The method of claim 15, wherein sending the second instantiation of the e-mail is further based upon the second default set of per-recipient attributes.

17. The method of claim 11, further comprising:
appending, by the e-mail client, a first recipient table including a first address of the first recipient and the first per-recipient attribute to the first instantiation of the e-mail; and
appending, by the e-mail client, a second recipient table including a second address of the second recipient and the second per-recipient attribute to the second instantiation of the e-mail.

18. The method of claim 11, further comprising:
appending, by the e-mail client, a recipient table including a first address of the first recipient, the first per-recipient attribute, a second address of the second recipient, and the second per-recipient attribute to the e-mail prior to sending the first instantiation of the e-mail and the second instantiation of the e-mail.

19. The method of claim 11, further comprising:
encoding, by the e-mail client, the e-mail and the recipient table prior to sending the first instantiation of the e-mail and the second instantiation of the e-mail.

20. An e-mail system, comprising:
an e-mail client system configured to:
determine a first per-recipient attribute for a first recipient, the first recipient being a first addressee of an e-mail;
determine a second per-recipient attribute for a second recipient, the second recipient being a second addressee of the e-mail, the first per-recipient attribute being different from the second per-recipient attribute; and
append a recipient table including a first address of the first recipient, the first per-recipient attribute, a second address of the second recipient, and the second per-recipient attribute to the e-mail; and
an e-mail server configured to:
receive the e-mail from the e-mail client system;
send a first instantiation of the e-mail to the first recipient based upon the first per-recipient attribute; and
send a second instantiation of the e-mail to the second recipient based upon the second per-recipient attribute.
